(19) United States
(12) Patent Application Publication
(10) Pub. No.: US 2023/0251161 A1
(43) Pub. Date: Aug. 10, 2023

(54) HIGH-PRECISION AND HIGH-THROUGHPUT MEASUREMENT OF PERCENTAGE LIGHT LOSS OF OPTICAL DEVICES

(71) Applicant: Applied Materials, Inc., Santa Clara, CA (US)

(72) Inventors: Baochen WU, Santa Clara, CA (US); Yangyang SUN, San Jose, CA (US); Ravi KOMANDURI, Milpitas, CA (US); Jinxin FU, Fremont, CA (US); Ludovic GODET, Sunnyvale, CA (US)

(21) Appl. No.: 18/163,766

(22) Filed: Feb. 2, 2023

Related U.S. Application Data
(60) Provisional application No. 63/308,826, filed on Feb. 10, 2022.

(51) Int. Cl. G01M 11/02

(52) U.S. Cl. CPC G01M 11/0207

(57) ABSTRACT

Embodiments described herein relate to an optical device metrology system including a light source to emit a light and a non-polarizing beam splitter to split the light into a first photodetector light path and an optical light path. A first photodetector is disposed in the first photodetector light path and measures a total power of the light. The optical device substrate is disposed in the optical light path and splits the light into a second and a third photodetector light path. A second photodetector is disposed in the second photodetector light path from the optical device substrate. The second photodetector measures a reflected power of the light. A third photodetector is disposed in the third photodetector light path. The third photodetector measures a transmitted power of the light. The controller receives measurements from the first, second, and third photodetectors to calculate a percentage light loss within the optical device substrate.

### CROSS-REFERENCE TO RELATED APPLICATIONS

This application claims benefit of U.S. Provisional Patent Application No. 63/208,826, filed Feb. 10, 2022, which is herein incorporated by reference in its entirety.

### BACKGROUND

### Field

Embodiments of the present disclosure generally relate to optical devices. More specifically, embodiments described herein relate to a measurement system and a method to measure percentage light loss of at least one of an optical film, optical device, or an optical device substrate.

### Description of the Related Art

Optical devices including waveguide combiners, such as augmented reality waveguide combiners, and flat optical devices, such as metasurfaces, are used to assist in overlaying images. Generated light is propagated through the optical device until the light exits the optical device and is overlaid on the ambient environment.

Fabricated optical devices tend to lose light through absorption or scattering as the light is propagated through the optical device or optical device substrate. The optical devices are fabricated from optical device substrates, and in some instances optical films, e.g., when an optical device is fabricated from an optical film disposed on an optical device substrate. It is beneficial to measure the percentage light loss from the optical film and the optical device substrate prior to, during, and after fabricating the optical device.

Therefore, what is needed in the art is a measurement system and a method to measure percentage light loss of at least one of an optical film, an optical device, or an optical device substrate.

### SUMMARY

In one embodiment, an optical device metrology system is provided. The optical device metrology system includes a light source operable to emit a light, a non-polarizing beam splitter disposed in a path of the light, a first photodetector, a second photodetector, a third photodetector, and a controller. The non-polarizing beam splitter is operable to split the light into a first photodetector light path and an optical light path. The first photodetector is disposed in the first photodetector light path and is operable to measure a total power of the light. The optical device substrate is disposed in the optical light path and operable to split the light into a second photodetector light path and a third photodetector light path. The second photodetector is disposed in the second photodetector light path from the optical device substrate. The second photodetector is operable to measure a reflected power of the light. The third photodetector is disposed in the third photodetector light path. The third photodetector is operable to measure a transmitted power of the light. The controller is operable to receive a plurality of measurements from the first photodetector, second photodetector, and third photodetector to calculate a percentage light loss within the optical device substrate.

In another embodiment, a method of using an optical device metrology system is provided. The method includes projecting a light from a light source toward a non-polarizing beam splitter; splitting the light into a first photodetector light path and an optical light path at the non-polarizing beam splitter; projecting the light to a first photodetector in the first photodetector light path; measuring a total power of the light in the first photodetector light path at the first photodetector; projecting the light to an optical device substrate in the optical light path; splitting the light into a second photodetector light path and a third photodetector light path at the optical device substrate; projecting the light to a second photodetector in the second photodetector light path; measuring a reflected power of the light in the second photodetector light path at the second photodetector; projecting the light to a third photodetector in the third photodetector light path; measuring a transmitted power of the light in the third photodetector light path at the third photodetector; collecting a plurality of measurements from the first photodetector, second photodetector, and third photodetector at a controller, the plurality of measurements comprising the total power, the reflected power, and the transmitted power; and calculating a percentage light loss at the optical device substrate using the plurality of measurements.

In yet another embodiment, a controller of an optical device metrology system is provided. The controller stores instructions that, when executed by a computer processor, cause the controller to calculate a percentage light loss of an optical device substrate using a plurality of measurements from a first photodetector, a second photodetector, and a third photodetector. The plurality of measurements are collected by projecting a light from a light source toward a non-polarizing beam splitter, measuring a total power of the light at the first photodetector in the first photodetector light path, measuring a reflected power of the light at the second photodetector in a second photodetector light path, and measuring a transmitted power of the light at the third photodetector in a third photodetector light path. The non-polarizing beam splitter splits the light into a first photodetector light path and an optical light path. The second photodetector light path is formed from the light reflecting off the optical device substrate disposed in the optical light path. The third photodetector light path is formed from the light transmitted through the optical device substrate disposed in the optical light path. The plurality of measurements comprises the total power, the reflected power, and the transmitted power.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a perspective, frontal view of an optical device substrate according to embodiments described herein.

FIG. 2 is a schematic view of an optical device metrology system according to embodiments described herein.

FIG. 3 is a schematic diagram of a controller according to embodiments described herein.

FIG. 4 is a flow diagram of a method of determining the percentage light loss according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. More specifically, embodiments described herein relate to an optical device metrology system for measuring the light lost in optical films, optical devices, and transparent optical device substrates.

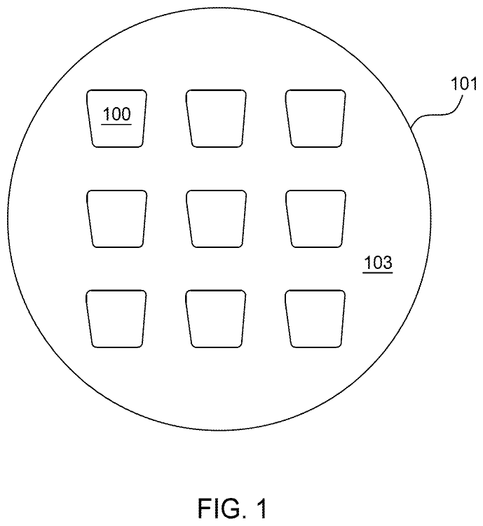

FIG. 1 is a perspective, frontal view of an optical device substrate 101 according to embodiments described herein. In some embodiments, the optical device substrate 101 includes a plurality of optical devices 100 disposed on a surface 103 of the optical device substrate 101. The optical devices 100 may be waveguide combiners utilized for virtual, augmented, or mixed reality. In some embodiments, which can be combined with other embodiments described herein, the optical devices 100 are flat optical devices, such as metasurfaces.

The optical device substrate 101 can be any optical device substrate used in the art, depending on the use of the optical device substrate 101. Additionally, the optical device substrate 101 may be of varying shapes, thicknesses, and diameters. For example, the optical device substrate 101 may have a diameter of about 150 mm to about 300 mm. The optical device substrate 101 may have a circular, rectangular, or square shape. The optical device substrate 101 may have a thickness of between about 300 μm to about 1 mm. Although only nine optical devices 100 are shown on the optical device substrate 101, any number of optical devices 100 may be disposed on the surface 103. The optical metrology system 200 and the method 400 described herein are utilized to measure the percentage light loss of the optical films, optical device substrates 101, and optical devices 100 described herein.

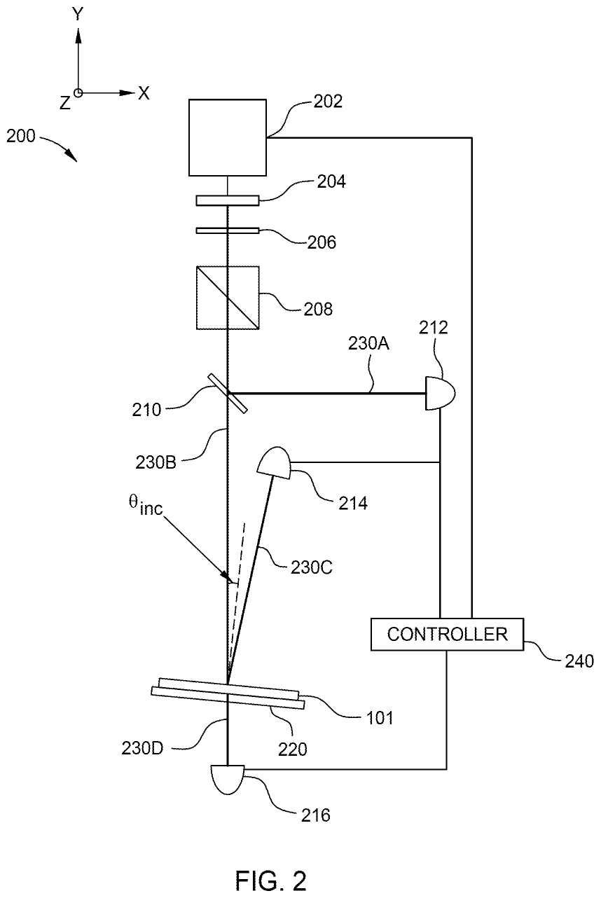

FIG. 2 is a schematic view of an optical device metrology system 200. The optical device metrology system 200 is operable to measure the amount of light lost (e.g., absorbed) by an optical device substrate 101, an optical film disposed on the optical device substrate 101, or an optical device 100. The optical device substrate 101, optical device 100, or optical device film of the optical device substrate 101 may be measured at one or more stages of manufacturing.

The optical device metrology system 200 includes light source 202, a fiber coupler 204, a half-wave plate 206, a polarizing beam splitter 208, a non-polarizing beam splitter 210, a first photodetector 212, a second photodetector 214, and a third photodetector 216. The light source 202, first photodetector 212, second photodetector 214, and third photodetector 216 are in communication with a controller 240.

The optical device metrology system 200 is operable to support the optical device substrate 101. The optical device substrate 101 may include at least one optical device 100 disposed on the optical device substrate 101. In some embodiments, the optical device substrate 101 includes an optical film disposed thereon. In some embodiments, the optical device substrate 101 may be disposed on a substrate support 220 (e.g., an edge ring) to support the optical device substrate 101 in the optical device metrology system 200.

The light source 202 is operable to emit a light through the fiber coupler 204. In one embodiment, which can be combined with other embodiments described herein, the light source 202 is a light-emitting diode (LED). In another embodiment, the light source is a laser, such as a red/green/blue (RGB) laser. The RGB laser can alternately or simultaneously emit a combination of blue light having a wavelength of about 473 nm, green light having a wavelength of about 520 nm, and red light having a wavelength of about 642 nm.

The light emitted from the light source 202 is split into a first photodetector light path 230A and an optical light path 230B at the non-polarizing beam splitter 210. The first photodetector light path 230A is directed toward the first photodetector 212. The first photodetector 212 is operable to measure a total power (Pₜₒₜ) of the light emitted from the light source 202. The optical light path 230B is directed toward the optical device substrate 101.

The light following the optical light path 230B is split into a second photodetector light path 230C and a third photodetector light path 230D at the optical device substrate 101. The second photodetector light path 230C is directed toward the second photodetector 214. The second photodetector 214 is operable to measure a reflected power (P_{refl}) of the light emitted from the light source 202. The second photodetector 214 is positioned at an incident angle θ_{inc} relative to the optical light path 230B. In one embodiment, the θ_{inc} is maintained so that the optical path length inside the optical device substrate 101 stays unchanged as different types of light are emitted from the light source 202. In one embodiment, the incident angle is about 6°±0.5°. In other embodiments, other angles may be used. The third photodetector light path 230D is directed toward the third photodetector 216. The third photodetector 216 is operable to measure a transmitted power (Pₜᵣₐₙₛ) of the light emitted from the light source 202.

The use of the first photodetector 212 disposed in the first photodetector light path 230A to measure the total power Pₜₒₜ, the second photodetector 214 disposed in the second photodetector light path 230C to measure the reflected power P_{refl}, and the third photodetector 216 in the third photodetector light path 230D to measure the transmitted power Pₜᵣₐₙₛ captures measurements of the power of the projected light at three detection points. The total power Pₜₒₜ, reflected power P_{refl}, and transmitted power Pₜᵣₐₙₛ along the three separate light paths allows for a fully-optical method of measuring percentage light loss. The optical device metrology system 200 provides for the capture of the three power measurements without contacting the optical device substrate 101 and does not require mode-excitation of the optical device substrate 101, optical device 100, or optical film. Measurements without contact and mode-excitation allow for increased precision of the percentage light loss measurements and increased throughput throughout manufacturing of the optical device substrates 101, optical devices 100, or optical films.

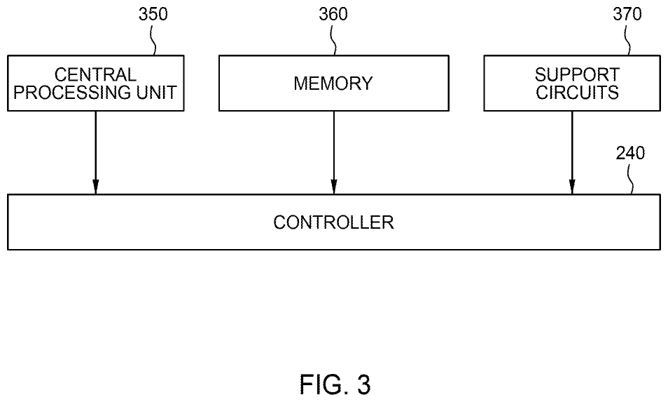

FIG. 3 illustrates the controller 240 of the optical device metrology system 200. The optical device metrology system 200 is in communication with the controller 240. The controller 240 facilitates the control and automation of the method 400 for measuring percentage light loss of the optical device substrates 101 described herein. The controller 240 may include a central processing unit (CPU) 350, a memory 360, and support circuits 370. The CPU 350 may be one of any form of computer processors that are used in industrial settings for controlling various processes and hardware (e.g., motors and other hardware) and monitoring the processes (e.g., changes in the percentage light loss in an optical device substrate 101 throughout the manufacturing process). The memory 360 is connected to the CPU and may be readily available memory, such as random access memory (RAM). Software instructions and data can be coded and stored within the memory 360 for instructing the CPU 350. The support circuits 370 are also connected to the CPU for supporting the processor. The support circuits 370 may include cache, power supplies, clock circuits, input/output circuitry, subsystems, and the like. A program (or computer instructions) readable by the controller determines which tasks are performable on the optical device substrate 101. The program may be software readable by the controller 340 and may include code to monitor, for example, the change in the percentage light loss in an optical device substrate 101 throughout the manufacturing process or the wavelength of light emitted by the light source 202.

The controller 240 is configured to facilitate the operation of the optical device metrology system 200. In some embodiments, the controller 240 includes one or more inputs (e.g., 3 inputs) for the first photodetector 212, second photodetector 214, and third photodetector 216, and a common ground. The controller 240 is operable to select the wavelength of light that is emitted from the light source 202. In some embodiments, the controller 240 may emit a red light, a blue light, or a green light simultaneously. In some embodiments, the controller 240 may emit some combination of blue light, red light, or green light simultaneously. In some embodiments, the controller 240 may alternate between a red light, a blue light, and a green light.

The controller 240 is operable to calculate the percentage light loss of the optical device substrate 101 using a plurality of measurements from the first photodetector 212, the second photodetector 214, and the third photodetector 216. The plurality of measurements includes the total power Pₜₒₜ, the reflected power P_{refl}, and the transmitted power Pₜᵣₐₙₛ. The three channels give data with both offsets and fluctuations of the order 100 nV.

Embodiments of the optical device metrology system 200 described herein provide for the ability to eliminate electrical noise, such as DC offsets, to increase the precision of the percentage light loss measurements. The DC offsets can come from, among other things, light source power drift or fluctuations in the photodetector readings. Any DC offsets in the optical device metrology system 200 would be measured by each of the first photodetector 212, second photodetector 214, and third photodetector 216. The controller 240 includes the common ground in order to eliminate the DC offsets. The controller 240 having a common ground between the first photodetector 212, second photodetector 214, and third photodetector 216 allows the controller 240 to determine the level of DC offsets in the optical device metrology system 200. The controller 240 ensures that the obtained power measurements from the first photodetector 212, second photodetector 214, and third photodetector 216 are non-floating, allowing for more accurate and precise measurement of the power obtained at each photodetector.

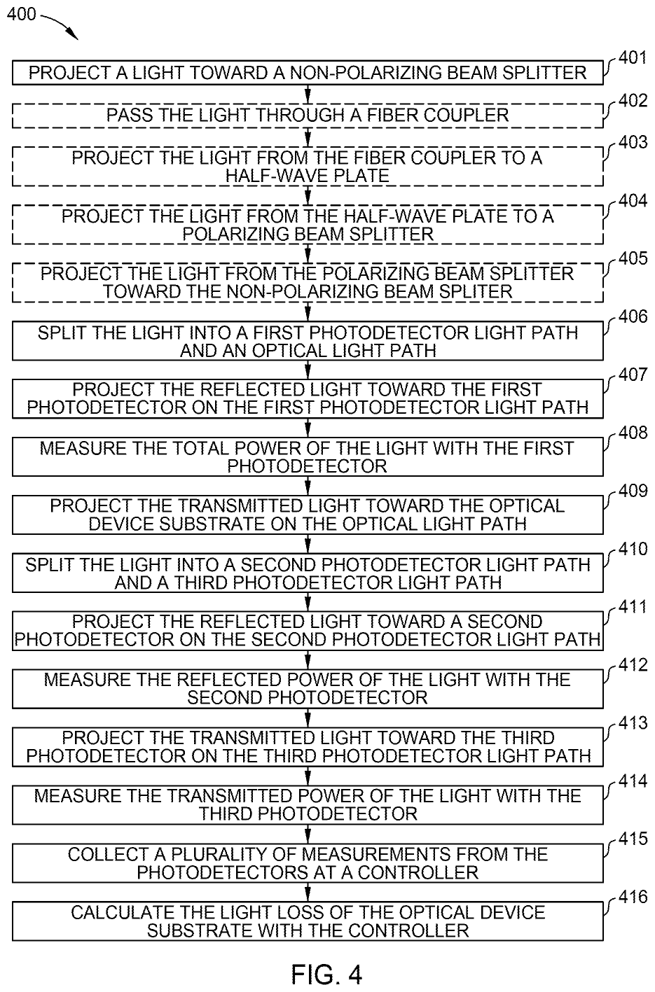

FIG. 4 is a flow diagram of a method 400 of determining the percentage light loss (e.g., optical loss) with an optical device metrology system 200. A controller 240 is operable to facilitate the operations of the method 400. At operation 401, a light is projected from a light source 202 toward a non-polarizing beam splitter 210. In some embodiments, at optional operation 402, the light is passed through a fiber coupler 204 to emit the light. The fiber coupler 204 couples the light from the light source 202 to allow for flexible optics set-ups.

At optional operation 403, the light is projected from the fiber coupler 204 to a half-wave plate 206. The half-wave plate 206 aligns the polarization of the light emitted from the fiber coupler 204. At optional operation 404, the light is projected from the half-wave plate to a polarizing beam splitter 208. The polarizing beam splitter 208 further fine tunes the alignment of the light emitted from the fiber coupler 204 and filters out non-aligned light. At optional operation 405, the light is projected from the polarizing beam splitter 208 toward the non-polarizing beam splitter 210.

At operation 406, the non-polarizing beam splitter 210 splits the light into a first photodetector light path 230A and an optical light path 230B. A first photodetector 212 is disposed in the first photodetector light path 230A. The first photodetector light path 230A is formed from the light that reflects off the non-polarizing beam splitter 210. An optical device substrate 101 is disposed in the optical light path 230B. The optical light path 230B is formed from the light that is transmitted through the non-polarizing beam splitter 210 and travels toward the optical device substrate 101.

At operation 407, the light that is reflected off the non-polarizing beam splitter 210 is projected towards to the first photodetector 212 on the first photodetector light path 230A. At operation 408, the total power Pₜₒₜ is measured by the first photodetector 212. The non-polarizing beam splitter 210 has a transmission/reflection splitting ratio. The total power (Pₜₒₜ) is calculated using a splitting ratio of the non-polarizing beam splitter 210. The non-polarizing beam splitter 210 can split the light from about 20% reflection (80% transmission) to about 80% reflection (20% transmission). In one embodiment, the light that is projected towards the first photodetector 212 and the light traveling toward the optical device substrate 101 are oriented at about a 90-degree angle to one another, though other angles are contemplated by this disclosure.

At operation 409, the light that is transmitted through the non-polarizing beam splitter 210 is projected towards the optical device substrate 101 on the optical light path 230B. In some embodiments, the optical device substrate 101 includes an optical film disposed over the optical device substrate 101. In some embodiments, the optical film is a patterned optical film. In some embodiments, the optical device substrate 101 includes one or more optical devices. At operation 410, the optical device substrate 101 splits the light into a second photodetector light path 230C and a third photodetector light path 230D. When the light interacts with the optical device substrate 101, a portion is absorbed within the optical device substrate 101 (e.g., a percentage light loss l), a portion is reflected (e.g., reflected power P_{refl}), and a portion is transmitted (e.g., transmitted power Pₜᵣₐₙₛ). A second photodetector 214 is disposed in the second photodetector light path 230C. A third photodetector 216 is disposed in the third photodetector light path 230D.

At operation 411, the portion of light that is reflected off the optical device substrate 101 is projected towards the second photodetector 214 on the second photodetector light path 230C. At operation 412, the reflected power P_{refl} is measured by the second photodetector 214. The second photodetector 114 is positioned at an incident angle θ_{inc} relative to the optical light path 230B. In one embodiment, the θ_{inc} is maintained so that the optical path length inside the optical device substrate 101 stays unchanged as different types of light are emitted from the light source 202. In one embodiment, the incident angle is about 6°±0.5°. In some embodiments, other angles may be used.

At operation 413, the portion of light that is transmitted through the optical device substrate 101 is projected towards the third photodetector 216 on the third photodetector light path 230D. At operation 414, the transmitted power Pₜᵣₐₙₛ is measured by the third photodetector 216.

At operation 415, a controller 240 collects a plurality of measurements from the first photodetector 212, the second photodetector 214, and the third photodetector 216. The plurality of measurements comprises the total power Pₜₒₜ, the reflected power P_{refl}, and the transmitted power Pₜᵣₐₙₛ. The total power Pₜₒₜ, reflected power P_{refl}, and transmitted power Pₜᵣₐₙₛ are measured simultaneously at the first photodetector 212, the second photodetector 214, and the third photodetector 216, respectively, to reduce drift or fluctuations in the light source 202. In some embodiments, the optical loss for blue light, green light, and red light can be measured individually.

At operation 416, the controller 240 calculates the percentage light loss l at the optical device substrate 101 using the plurality of measurements. The percentage light loss l (e.g., optical loss) can be measured using equation (1):

$$l = 1 - \frac{{P}_{refl}}{{P}_{t o t}} - \frac{{P}_{t r a n s}}{{P}_{t o t}} \qquad ( 1 )$$

In some embodiments, the percentage light loss of the optical device substrate 101 is calculated before the optical device substrate 101 has been processed. In other embodiments, the percentage light loss of the optical device substrate 101 is calculated during the processing of the optical device substrate 101. In still other embodiments, the percentage light loss of the optical device substrate 101 is calculated after the processing of the optical device substrate 101. In still other embodiments, the percentage light loss of the optical device substrate 101 is calculated before, during, and after processing, or some combination thereof.

The method 400 is able to give measurements from the first photodetector 212, second photodetector 214, and third photodetector 216 in about the 100 mV range, allowing the three channels give data with both offsets and fluctuations on the order of 100 nV (e.g., 10⁻⁶ precision). A fully-optical method allows for high-throughput and measurement of percentage light loss with wavelengths ranging from ultraviolet to infrared. A fully-optical method means that the optical device substrate 101 that is being measured interacts only with the light projected onto it, and not with any other physical apparatus. The design is compatible with multiple substrate chuck designs, allowing full automation of the measurement.

In summation, optical device metrology systems and methods of calculating the percentage light loss of an optical device substrate or optical device are provided herein. The optical device metrology system splits an emitted light into a first photodetector light path and an optical light path. The optical device substrate splits the light into a second photodetector light path and a third photodetector light path. A first photodetector is disposed in the first photodetector light path, a second photodetector is disposed in the second photodetector light path, and a third photodetector is disposed in a third photodetector light path. The use of the photodetectors captures measurements of the power of the projected light at three detection points along the three separate light paths. The total power Pₜₒₜ, reflected power P_{refl}, and transmitted power Pₜᵣₐₙₛ along the three separate light paths allows for a fully-optical method of measuring percentage light loss. The optical device metrology system provides for the capture of the three powers measurements without contacting the optical device substrate and does not require mode-excitation of the optical device substrate, optical device, or optical film. Measurements without contact and mode-excitation allow for increased precision of the percentage light loss measurements and increased throughput throughout manufacturing of the optical device substrates, optical devices, or optical films. The percentage light loss is calculated at a controller, which receives the measurements from the first photodetector, second photodetector, and third photodetector. The percentage light loss can be calculated before, during, or after processing the optical device substrate or optical device, enabling higher throughput. A common ground eliminates DC offsets within the optical device metrology system, allowing for the optical metrology system to measure offsets and fluctuations on the order of 100 nV (e.g., 10⁻⁶ precision of percentage light loss measurements).

What is claimed is:

1. An optical device metrology system, comprising:
a light source operable to emit a light;
a non-polarizing beam splitter disposed in a path of the light, the non-polarizing beam splitter operable to split the light into a first photodetector light path and an optical light path;
a first photodetector disposed in the first photodetector light path operable to measure a total power of the light;
a second photodetector disposed in a second photodetector light path from an optical device substrate, wherein the optical device substrate is disposed in the optical light path and operable to split the light in the second photodetector light path into the second photodetector light path and a third photodetector light path, the second photodetector operable to measure a reflected power of the light;
a third photodetector disposed in the third photodetector light path, the third photodetector operable to measure a transmitted power of the light; and
a controller, the controller operable to receive a plurality of measurements from the first photodetector, second photodetector, and third photodetector to calculate a percentage light loss within the optical device substrate.

2. The optical device metrology system of claim 1, wherein the second photodetector is positioned at an incident angle of about 5.5° to about 6.5° from the optical light path.

3. The optical device metrology system of claim 1, wherein the controller comprises a common ground for the plurality of measurements.

4. The optical device metrology system of claim 1, further comprising:
a half-wave plate; and
a polarizing beam splitter, wherein the half-wave plate and polarizing beam splitter are operable to align the polarization of the light emitted from the light source.

5. The optical device metrology system of claim 1, wherein a substrate support is operable to support the optical device substrate.

6. The optical device metrology system of claim 1, the optical device metrology system is non-mode excitation.

7. A method, comprising:
projecting a light from a light source toward a non-polarizing beam splitter;
splitting the light into a first photodetector light path and an optical light path at the non-polarizing beam splitter;
projecting the light to a first photodetector in the first photodetector light path;
measuring a total power of the light in the first photodetector light path at the first photodetector;
projecting the light to an optical device substrate in the optical light path;
splitting the light into a second photodetector light path and a third photodetector light path at the optical device substrate;
projecting the light to a second photodetector in the second photodetector light path;
measuring a reflected power of the light in the second photodetector light path at the second photodetector;
projecting the light to a third photodetector in the third photodetector light path;
measuring a transmitted power of the light in the third photodetector light path at the third photodetector;
collecting a plurality of measurements from the first photodetector, second photodetector, and third photodetector at a controller, the plurality of measurements comprising the total power, the reflected power, and the transmitted power; and
calculating a percentage light loss at the optical device substrate using the plurality of measurements.

8. The method of claim 7, further comprising:
passing the light from the light source through a fiber coupler;
projecting the light from the fiber coupler to a half-wave plate;
projecting the light from the half-wave plate to a polarizing beam splitter; and
projecting the light from the polarizing beam splitter toward the non-polarizing beam splitter.

9. The method of claim 7, wherein the method is a fully-optical method.

10. The method of claim 7, wherein the percentage light loss of the optical device substrate can be measured before a processing of the optical device substrate, during the processing of the optical device substrate, after the processing of the optical device substrate, or a combination thereof.

11. The method of claim 7, wherein the second photodetector is positioned at an incident angle of about 5.5° to about 6.5° from the optical light path.

12. The method of claim 7, wherein a substrate support is operable to support the optical device substrate.

13. The method of claim 7, wherein the controller comprises a common ground for the plurality of measurements.

14. A controller of an optical device metrology system storing instructions that, when executed by a computer processor, cause the controller to:
calculate a percentage light loss of an optical device substrate using a plurality of measurements from a first photodetector, a second photodetector, and a third photodetector, wherein the plurality of measurements are collected by:
projecting a light from a light source toward a non-polarizing beam splitter, wherein the non-polarizing beam splitter splits the light into a first photodetector light path and an optical light path;
measuring a total power of the light at the first photodetector in the first photodetector light path;
measuring a reflected power of the light at the second photodetector in a second photodetector light path, wherein the second photodetector light path is formed from the light reflecting off the optical device substrate disposed in the optical light path; and
measuring a transmitted power of the light at the third photodetector in a third photodetector light path, wherein the third photodetector light path is formed from the light transmitted through the optical device substrate disposed in the optical light path;
wherein the plurality of measurements comprises the total power, the reflected power, and the transmitted power.

15. The controller of claim 14, wherein a substrate support is operable to support the optical device substrate.

16. The controller of claim 14, wherein the controller further comprises a common ground for the plurality of measurements.

17. The controller of claim 14, wherein the controller is operable to select a wavelength of light that is emitted from the light source.

18. The controller of claim 17, wherein the wavelength of light comprises a blue light, a red light, a green light, or a combination thereof.

19. The controller of claim 14, wherein the second photodetector is positioned at an incident angle of about 5.5° to about 6.5° from the optical light path.

20. The controller of claim 14, wherein the percentage light loss of the optical device substrate can be measured before a processing of the optical device substrate, during the processing of the optical device substrate, after the processing of the optical device substrate, or a combination thereof.
